(19) United States
(12) Patent Application Publication
(10) Pub. No.: US 2019/0040219 A1
(43) Pub. Date: Feb. 7, 2019

(54) SYSTEMS AND METHODS FOR TREATING ELASTOMERIC WORKPIECES

(71) Applicant: Inhance Technologies, LLC, Houston, TX (US)

(72) Inventors: Subramanian Iyer, Katy, TX (US); Andrew M. Thompson, West Chester, PA (US)

(21) Appl. No.: 16/054,289

(22) Filed: Aug. 3, 2018

Related U.S. Application Data
(60) Provisional application No. 62/541,329, filed on Aug. 4, 2017.

(51) Int. Cl. C08J 7/12; B01J 19/00; B01J 19/14

(52) U.S. Cl. CPC C08J 7/126; B01J 19/0053; B01J 19/14; B01J 2219/00761; C08J 2311/00; C08J 2319/00; C08J 2323/16; C08J 2309/06

(57) ABSTRACT

A method of treating an elastomeric workpiece is provided. The method includes: (a) providing an elastomeric workpiece; and (b) altering a mechanical property of the elastomeric workpiece by fluorinating the elastomeric workpiece in a controlled environment.

### CROSS-REFERENCE TO RELATED APPLICATION

This application claims the benefit of U.S. Provisional Patent Application No. 62/541,329, filed Aug. 4, 2017, the contents of which are incorporated herein by reference.

### FIELD

The invention relates to systems and methods for treating elastomeric workpieces, and more particularly, to improved systems and methods for fluorinating such elastomeric workpieces.

### BACKGROUND

Various methods of treating elastomeric materials using fluorination (or similar techniques) are known in the art. Exemplary techniques are disclosed in, for example: U.S. Pat. No. 3,992,221 (Homsy, et al.); U.S. Pat. No. 5,214,102 (Zielinski, et al.); U.S. Pat. No. 5,274,049 (Zielinski, et al.); and U.S. Pat. No. 8,091,855 (Huang).

Such methods may be used, for example, to alter the surface property (i.e., the coefficient of friction) of the elastomeric material. Improved methods of treating elastomeric materials, and systems for accomplishing such methods, would be desirable.

### SUMMARY

According to an exemplary embodiment of the invention, a method of treating an elastomeric workpiece is provided. The method includes: (a) providing an elastomeric workpiece; and (b) altering a mechanical property (e.g., a tensile property such as the elastic modulus, an impact property, a wear property, etc.) of the elastomeric workpiece by fluorinating the elastomeric workpiece in a controlled environment.

According to another exemplary embodiment of the invention, a system for treating an elastomeric workpiece is provided. The system includes: (a) a chamber; (b) a control system configured to control an environment within the chamber to fluorinate workpieces within the chamber; and (c) an elastomeric workpiece processed within the chamber, a mechanical property (e.g., a tensile property such as the elastic modulus, an impact property, a wear property, etc.) of the elastomeric workpiece being altered through a fluorination process within the chamber.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIGS. 1A-1F are a series of block diagrams of a system for treating an elastomeric workpiece, collectively illustrating a method of treating the elastomeric workpiece, in accordance with an exemplary embodiment of the invention; and

FIG. 2 is a flow diagram illustrating a method of treating an elastomeric workpiece in accordance with an exemplary embodiment of the invention.

### DETAILED DESCRIPTION

In accordance with certain exemplary embodiments of the invention, certain mechanical properties of elastomeric workpieces may be improved through fluorination techniques. For example, such altered mechanical properties (e.g., a tensile property such as an elastic modulus or a tensile strength, an impact property, a wear property, etc.) may allow the workpiece to be used in more demanding applications. Exemplary ranges of improvement (e.g., increase) in a mechanical property of the fluorinated workpiece (such as a tensile property), as compared to the unfluorinated workpiece, are between 10-100%, at least 25%, at least 50%.

According to aspects of the invention, fluorination of these elastomers may be achieved under sub atmospheric conditions, under positive pressure, under vacuum, etc. In certain examples, the chamber housing the workpieces (in which the fluorination is to be carried out) is evacuated completely of any atmosphere. Then, a fluorinating gas (e.g., pure fluorine gas, a fluorine gas mixture, etc.) is added to the chamber. Example gases that can be added include pure fluorine, fluorine and inert gas mixtures (e.g., nitrogen, carbon dioxide, argon, etc.), etc. The exact conditions for the process will depend on the specific application (e.g., the elastomeric material of the workpiece, the desired mechanical property values such as the desired tensile property values, etc).

Through the fluorination process of the surface of the workpiece, mechanical properties (e.g., tensile properties, impact properties, wear properties, etc.) of the workpiece may be changed. That is, fluorination may be utilized to modify the surface of the elastomeric workpiece to the order of a few microns, which can alter the mechanical properties to significantly enhance them.

Exemplary elastomeric workpieces include dropper bulbs, gaskets, seals, medical plungers, etc. Exemplary applications for the elastomeric workpieces include healthcare applications, industrial applications, consumer applications, and the oil and gas industry. The workpiece being treated in accordance with the invention may be the actual finished workpiece (e.g., a gasket, a seal, etc.), or may be a workpiece of a bulk elastomeric material that will later be processed into the finished workpiece(s).

To illustrate an example of inventive fluorination processes affecting mechanical properties (in this example, tensile properties) of elastomeric workpieces, experiments were done with the results shown in Tables 1 and 2. These tables illustrate a significant improvement (increase) in elastic modulus after the inventive fluorination treatment.

More specifically, Table 1 illustrates three (3) exemplary mechanical (in this case, tensile) properties of five (5) different exemplary elastomeric materials prior to fluorination.

TABLE 1

| Elastomeric | Tensile strength, | Elastic modulus, | Elongation at break, |
|---|---|---|---|
| Material | Mpa | Mpa | % |
| Nitrile | 2.9 | 4.2 | 305 |
| Neoprene | 3.3 | 5.43 | 230.8 |
| EPDM | 3.91 | 5.62 | 397.2 |
| Santoprene | 2.48 | 5.9 | 385.6 |
| SBR | 1.57 | 8.18 | 141.75 |

Table 2 illustrates the same three (3) exemplary mechanical (in this case, tensile) properties of the same exemplary elastomeric materials, but after fluorination according to exemplary embodiments of the invention.

TABLE 2

| Elastomeric | Tensile strength, | Elastic modulus, | Elongation at break, |
|---|---|---|---|
| Material | Mpa | Mpa | % |
| Nitrile | 2.42 | 7.49 | 131.75 |
| Neoprene | 3.37 | 8.46 | 240.5 |
| EPDM | 3.02 | 6.36 | 754 |
| Santoprene | 3.1 | 7.94 | 264.2 |
| SBR | 2.94 | 13.64 | 141.8 |

The exemplary processes used to treat (fluorinate) the five (5) elastomeric materials listed in Tables 1 and 2 may be summarized as follows. First, the workpieces (formed of the elastomeric materials) were placed in a chamber (e.g., an autoclave) set to a temperature of 160° F. Second, the chamber was completely evacuated (and made devoid) of any oxygen, by purging with 100% nitrogen. The example purging process was conducted as follows: (a) the chamber was pulled down to 6 mm of vacuum; (b) nitrogen was added to 400 mm; (c) nitrogen was pulled down to 6 mm; (d) steps (b) and (c) were repeated three (3) times to ensure minimal oxygen in the chamber. Third, a fluorinated gas mixture (i.e., an 80/20 mixture of nitrogen/fluorine) was added to the chamber. Fourth, the fluorinated gas mixture was kept in the chamber for a desired reaction time, in this case, for a minimum of one hour. Fifth, after the reaction time, the chamber was purged with 100% nitrogen, three (3) times as described in the second step, to remove any residual reaction gases. The purge was sent through an alumina column to absorb any unreacted fluorine as well as reaction off gases. Sixth, the chamber was then brought up to atmospheric pressure by letting air into the chamber, and the workpieces were removed from the chamber.

Of course, the process described above, which provided the test data shown in Tables 1 and 2, is exemplary in nature. Different processes for treating elastomeric workpieces through fluorination are contemplated.

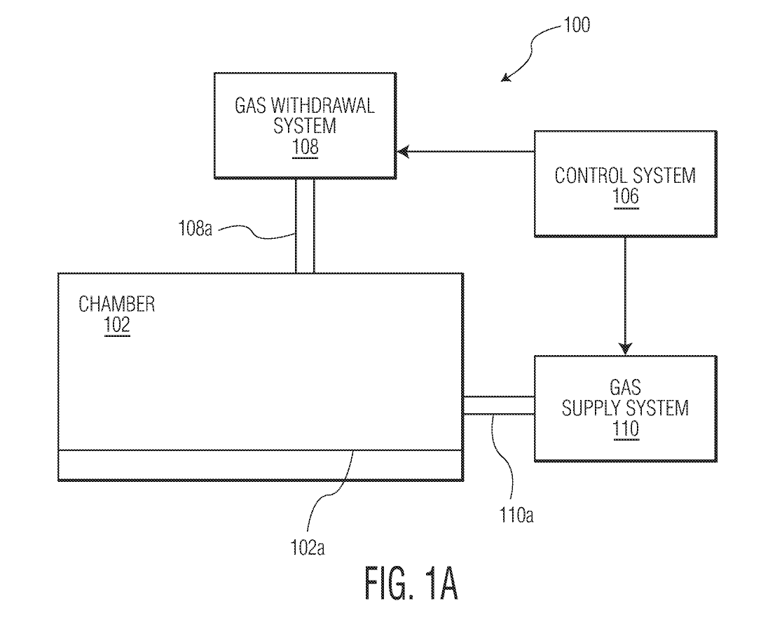

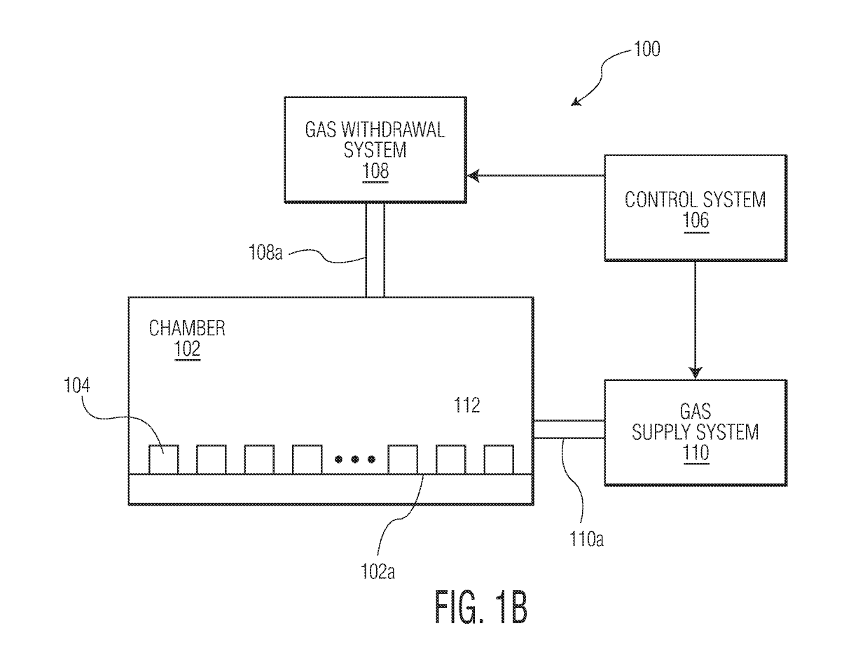

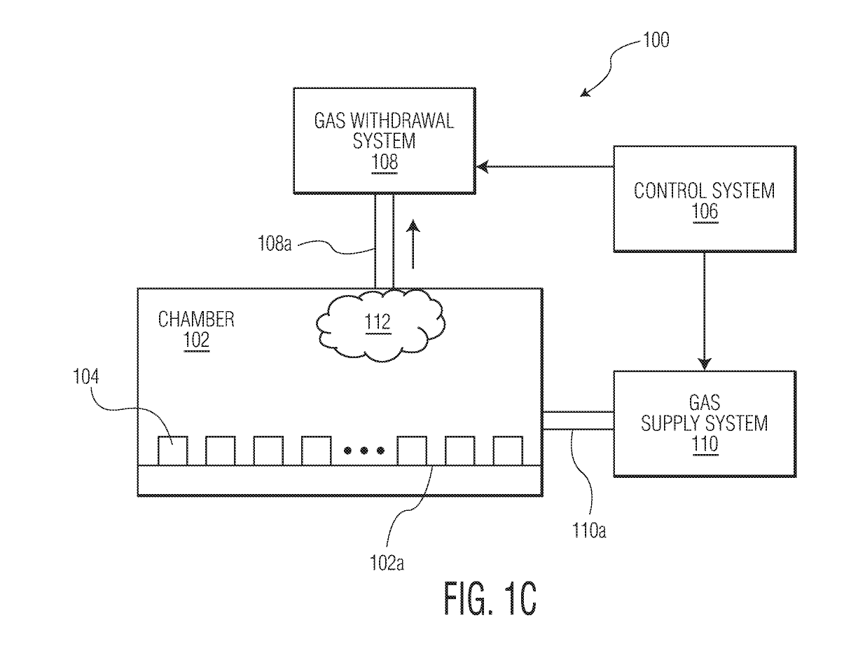

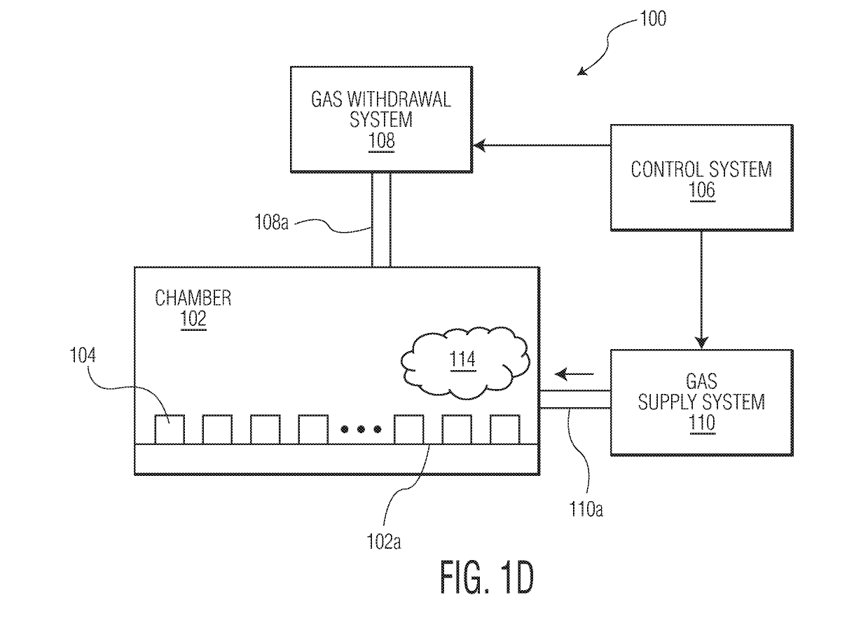

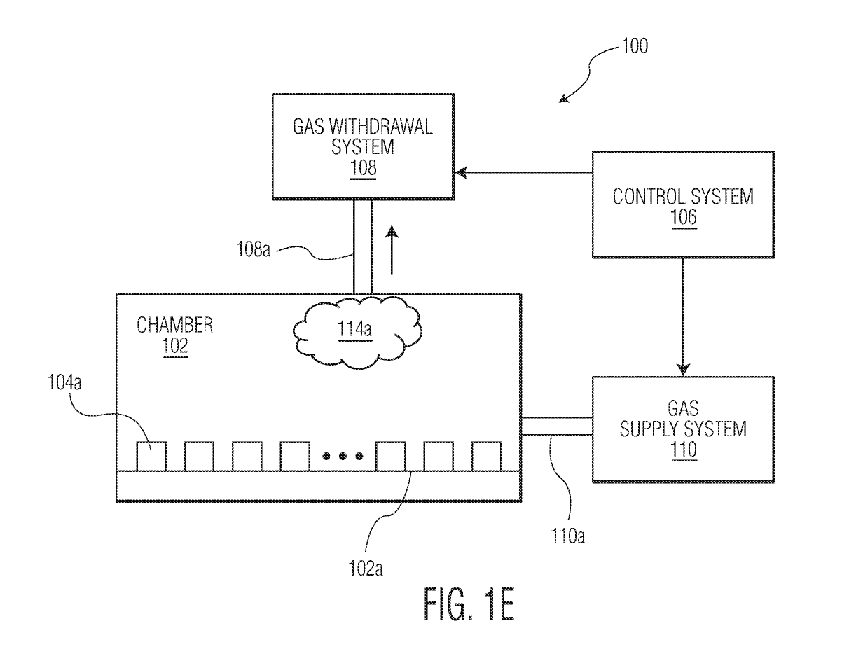

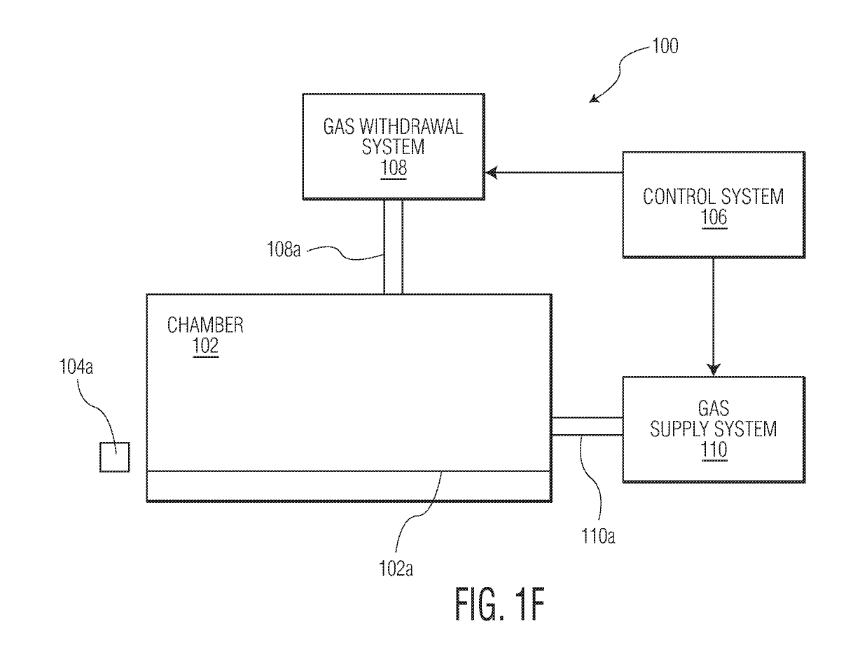

FIG. 1A illustrates a system 100 for treating elastomeric workpieces. System 100 includes a chamber 102 configured to receive one or more elastomeric workpieces. In the example shown in FIG. 1A, chamber 102 includes a shelf 102a configured to support a plurality of elastomeric workpieces for processing. Of course, other configurations of a chamber are contemplated. System 100 also includes a control system 106 (e.g., using software installed on, and/or accessible by, a computer element of control system 106) configured to control the environment within chamber 102 to fluorinate workpieces within chamber 102. Control system 106 works with a gas withdrawal system 108, and a gas supply system 110. Specifically, gas withdrawal system 108 may be used (as controlled by control system 106, and with piping 108a) to prepare chamber 102 to have an anaerobic environment (e.g., by removing air from chamber 102, by creating a full/partial vacuum environment in chamber 102, etc.). Likewise, gas supply system 110 may be used (as controlled by control system 106, and with piping 110a) to purge chamber 102 (e.g., with nitrogen as described above), and to fluorinate the elastomeric workpieces by having a controlled environment using fluorinated gas (e.g., pure fluorine gas, a mixture of fluorine and another gas, etc.).

In FIG. 1B, a plurality of elastomeric workpieces 104 have been provided in chamber 102. For example, workpieces 104 may be provided on shelf 102a, as shown in FIG. 1B. Workpieces 104 may be exposed directly to the atmospheric conditions in chamber 102. In other exemplary configurations, one or more workpieces 104 may be provided in an open container within chamber 102; one or more workpieces may be provided in a container that may be impregnated by a gas, such as a mesh container; among other configurations.

In FIG. 1C, chamber 102 is prepared to have an anaerobic environment, for example, by withdrawing oxygen 112 from chamber 102 using gas withdrawal system 108 (as controlled by control system 106). Specifically, system 108 may include a pump, motor, or other equipment, used in conjunction with piping 108a, to withdraw oxygen 112 from chamber 102. In other examples, system 108 may be used to draw a vacuum (e.g., a full vacuum, a partial vacuum, etc.) to prepare chamber 102 to have an anaerobic environment.

In FIG. 1D, workpieces 104 are fluorinated in chamber 102 using a fluorinating gas 114. Specifically, gas supply system 110 is used (as controlled by control system 106) to pump or otherwise direct fluorinating gas 114 into chamber 102. Fluorinating gas 114 may be, for example: pure fluorine gas; fluorine gas mixed with an inert gas (e.g., nitrogen, carbon dioxide, argon, etc.); etc. By providing fluorinating gas 114 into chamber 102, workpieces 104 are fluorinated sufficiently to alter a mechanical property (e.g., a tensile property such as an elastic modulus) of workpieces 104.

In FIG. 1E, gas withdrawal system 108 (as controlled by control system 106) is used to withdraw modified fluorinating gas 114a from chamber 102. That is, as will be appreciated by those skilled in the art, the fluorinating gas (originally referred to as fluorinating gas 114) is modified in the chamber, due to its reaction with the workpieces during the fluorination process. Thus, in FIG. 1E, a modified fluorinating gas 114a is removed from the chamber. In FIG. 1F, treated workpieces 104a (now treated, with an altered tensile property—referred to as workpieces 104a instead of untreated workpieces 104), are now withdrawn from chamber 102.

While FIGS. 1A-1F, illustrate a single control system 106 configured to operate each of gas withdrawal system 108 and gas supply system 114, it is understood that independent control systems 106 (e.g., programmable control systems such as programmable logic controllers, computer controlled systems, etc.) may be utilized to control each of systems 108 and 114.

While FIGS. 1A-1F illustrate a distinct gas withdrawal system 108, and a distinct gas supply system 110, it will be understood by those skilled in the art that such elements may be combined in certain applications to save on cost/efficiency.

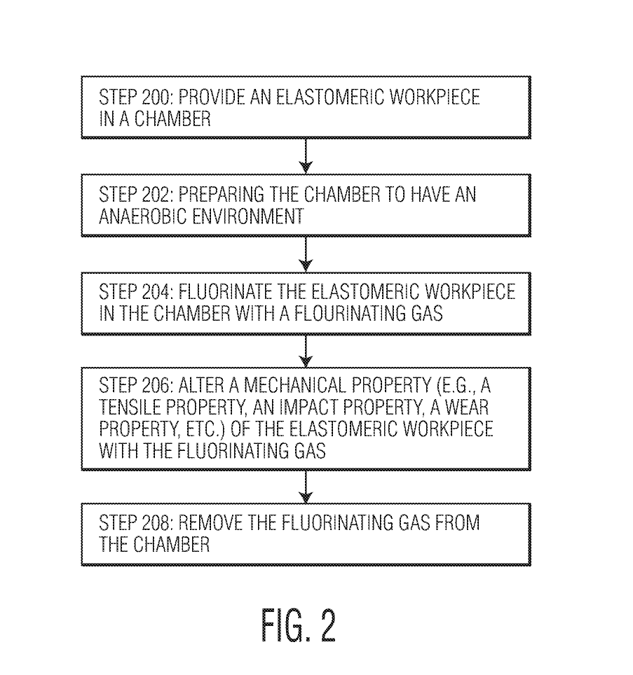

FIG. 2 is a flow diagram illustrating a method of treating an elastomeric workpiece. As is understood by those skilled in the art, certain steps included in the flow diagram may be omitted; certain additional steps may be added; and the order of the steps may be altered from the order illustrated.

At Step 200, an elastomeric workpiece is provided in a chamber (e.g., chamber 102 shown in FIGS. 1A-1F). At Step 202, the chamber is prepared to have an anaerobic environment (e.g., using a gas withdrawal system 108 controlled by control system 106, as shown in FIG. 1C). At Step 204, the elastomeric workpiece is fluorinated in the chamber with a fluorinating gas (e.g., using gas supply system 114 controlled by control system 106, as shown in FIG. 1D) (e.g., where the fluorinating step may be conducted under negative pressure, under positive pressure, under vacuum pressure, under a combination, etc.). At Step 206, a mechanical property (e.g., a tensile property such as an elastic modulus) of the elastomeric workpiece is altered with the fluorinating gas. That is, through the fluorinating gas provided in Step 204 (where the fluorinating gas may be provided for a desired, and perhaps predetermined, reaction time, in the chamber), the mechanical property of the elastomeric workpiece is altered. At Step 208, the fluorinating gas is removed from the chamber (e.g., using gas withdrawal system 108 controlled by control system 106, as shown in FIG. 1E).

As will be appreciated by those skilled in the art, the inventive process details, and the inventive system details, may vary significantly depending on the application. For example, a given elastomeric workpiece treated according to the invention may be relatively small (e.g., less than a centimeter in length), or may be much larger (e.g., several meters in length). Thus, the chamber size (and process equipment engaged with the chamber) may vary considerably.

Likewise, process details may vary considerably. For example, uniform temperature control in the chamber during fluorination versus temperature ramping or variable temperature control. Uniform fluorinated gas flow during fluorination versus variable gas flow. Of course, many other process variables will be application specific, as will be understood by those skilled in the art.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of treating an elastomeric workpiece, the method comprising the steps of:
(a) providing an elastomeric workpiece; and
(b) altering a mechanical property of the elastomeric workpiece by fluorinating the elastomeric workpiece in a controlled environment.

2. The method of claim 1 wherein step (b) includes altering a tensile property of the elastomeric workpiece.

3. The method of claim 1 wherein step (b) includes altering an impact property of the elastomeric workpiece.

4. The method of claim 1 wherein step (b) includes altering a wear property of the elastomeric workpiece.

5. The method of claim 1 wherein step (b) includes altering an elastic modulus of the elastomeric workpiece.

6. The method of claim 1 wherein step (b) includes increasing an elastic modulus of the elastomeric workpiece by at least 25%.

7. The method of claim 1 wherein step (b) includes increasing an elastic modulus of the elastomeric workpiece by at least 50%.

8. The method of claim 1 wherein step (b) includes fluorinating the elastomeric workpiece in a chamber.

9. The method of claim 8 further comprising a step of preparing the chamber to have an anaerobic environment prior to step (b).

10. The method of claim 1 wherein step (b) includes fluorinating the elastomeric workpiece in the controlled environment using pure fluorine.

11. The method of claim 1 wherein step (b) includes fluorinating the elastomeric workpiece in the controlled environment using a gas mixture including fluorine mixed with an inert gas.

12. The method of claim 1 wherein step (b) includes fluorinating the elastomeric workpiece in the controlled environment using a gas mixture including fluorine mixed with at least one additional gas, the at least one additional gas including at least one of nitrogen, carbon dioxide, and argon.

13. A system for treating an elastomeric workpiece, the system comprising:
(a) a chamber;
(b) a control system configured to control an environment within the chamber to fluorinate workpieces within the chamber; and
(c) an elastomeric workpiece processed within the chamber, a mechanical property of the elastomeric workpiece being altered through a fluorination process within the chamber.

14. The system of claim 13 wherein a tensile property of the elastomeric workpiece is altered through the fluorination process within the chamber.

15. The system of claim 13 wherein an impact property of the elastomeric workpiece is altered through the fluorination process within the chamber.

16. The system of claim 13 wherein a wear property of the elastomeric workpiece is altered through the fluorination process within the chamber.

17. The system of claim 13 wherein an elastic modulus of the elastomeric workpiece is altered within the chamber.

18. The system of claim 13 wherein an elastic modulus of the elastomeric workpiece is increased by at least 25% within the chamber.

19. The system of claim 13 wherein an elastic modulus of the elastomeric workpiece is increased by at least 50% within the chamber

20. The system of claim 13 further comprising piping to prepare the chamber to have an anaerobic environment prior to the fluorination process.

21. The system of claim 13 wherein the control system provides a supply of pure fluorine to the chamber during the fluorination process.

22. The system of claim 13 wherein the control system provides a gas mixture including fluorine mixed with an inert gas to the chamber during the fluorination process.

23. The system of claim 13 wherein the control system provides a gas mixture including fluorine mixed with at least one additional gas to the chamber during the fluorination process, the at least one additional gas including at least one of nitrogen, carbon dioxide, and argon.
